(19) United States
(12) Patent Application Publication
(10) Pub. No.: US 2025/0059470 A1
(43) Pub. Date: Feb. 20, 2025

(54) NEW CATIONIC POLYMERS, PROCESS FOR PRODUCING THE SAME FROM UREA DIAMINE CONDENSATES AND POLYEPOXIDE DERIVATIVES, AND USES THEREOF

(71) Applicant: SPECIALTY OPERATIONS FRANCE, Lyon (FR)

(72) Inventors: Wojciech Bzducha, Courbevoie (FR); Sujandi Zhou, Singapore (SG); David James Wilson, Coye-la-Foret (FR)

(73) Assignee: SPECIALTY OPERATIONS FRANCE, Lyon (FR)

(21) Appl. No.: 18/721,134

(22) PCT Filed: Dec. 6, 2022
(86) PCT No.: PCT/EP2022/084535

§ 371 Date: Jun. 17, 2024

(30) Foreign Application Priority Data
Dec. 17, 2021 (EP) 21215378.7

(51) Int. Cl. C11D 3/37; C08G 81/00; C11D 3/00

(52) U.S. Cl. CPC C11D 3/3726; C08G 81/00; C11D 3/0036

(57) ABSTRACT

The present invention relates to new cationic polymers, a synthesis process for preparing them from urea diamine condensates and polyepoxide derivatives, notably bisepoxide derivatives, and to the use of said new cationic polymers for surface treatment applications including, but not limited to, home and personal care applications as well as industrial and institutional cleaning applications.

This application claims priority to the application filed on Dec. 17, 2021 in Europe with Nr 21215378.7, the whole content of this application being incorporated herein by reference for all purposes.

The present invention relates to new cationic polymers, a synthesis process for preparing them from urea diamine condensates and polyepoxide derivatives, notably bisepoxide derivatives, and to the use of said new cationic polymers for surface treatment applications including, but not limited to, home and personal care applications as well as industrial and institutional cleaning applications.

### BACKGROUND

Cationic polymers obtained by reaction between monourea diamine condensates and dichloroalkyl ethers (notably bis-chloroethyl ethers) are known for their antimicrobial properties on one hand from WO11148950 A1, and for their performance for fixing colors and/or inhibiting the running of colors in laundry formulations on the other hand from US 2009/0005286 A1. Unfortunately, even if their performances are recognized in said applications, such highly cationic polymers are now classified as H410, i.e. very toxic to aquatic life with long lasting effects.

There is thus a need to find new chemical solutions with an improved eco-toxicity profile while preserving or even improving the surface treatment performances. The new chemical solution that is expected in this field would in addition present an improved biodegradability profile compared to already known cationic polymers made from monourea diamine condensates and dichloroalkyl ethers.

### BRIEF DESCRIPTION

One aim of the invention is thus to provide a new cationic polymer, that is able to replace existing cationic polymers in all applications they are intended for, notably as hygiene booster agent and dye transfer inhibitor, and that present a good eco-toxicity profile and a better biodegradability compared to existing cationic polymers. The invention further aims at providing a process that allow preparing such new cationic polymers, formulations comprising the same and various uses of said polymers.

To this end, the instant invention provides a new family of polymers, which reveal to provide especially good performances in surface treatment application, notably as hygiene booster agent and dye transfer inhibitor, while being harmless to the environment.

More precisely, according to a first aspect, one subject matter of the instant invention is a new polymer comprising the following repeating unit of formula I:

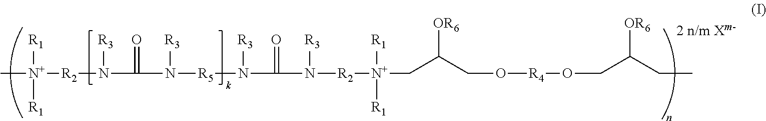

wherein:
R₁ are each independently a hydrogen atom, a C₁ to C₄ alkyl or hydroxyalkyl group, or a C₂ to C₄ alkenyl group;
R₂ are each independently a C₂ to C₁₀ alkylene group;
R₃ are each independently a hydrogen atom, a C₁ to C₄ alkyl or hydroxyalkyl group, or a C₂ to C₄ alkenyl group;
R₄ is selected in the group consisting of
—CH₂—CH(OH)—CH₂—; —CH₂—CH(CH₂OH)—; —CH₂—CH(O—CH₂—CH(OR₆)—CH₂)—CH₂—; —CH₂—CH(CH₂O—CH₂—CH(OR₆)—CH₂)—; a C₃ to C₁₀ alkylene; an arylene and an oxyalkylene group of formula A:

(—CHR₇CH₂)ₐ—(OCH₂CHR₈)_{b}—(OCH₂CHR₉)_{c}—(OCH₂CHR₁₀)_{d} (A)
wherein
“a” represents 1;
“b” represents an integer of 1 or more;
“c” and “d” represent independently from one another an integer of 0 or more; and R₇, R₃, R₉ and R₁₀ represent independently from one another a hydrogen atom or a C₁ to C₄ alkyl group;
R₅ represents an alkylene group, an oxyalkylene group of formula A, a cycloalkylene group, or an arylene group, optionally substituted and/or interrupted by one or more heteroatoms or heteroatom containing groups;
R₆ represents a hydrogen atom or a radical deriving from any oxirane containing compound present in the reaction mixture during the synthesis process of the polymer of the invention and that reacted by ring opening reaction with any OH or O⁻ group present on the polymer of the invention during its synthesis;
k represents a positive integer from 0 to 20;
n represents a positive integer from 1 to 50
m represents a positive integer from 1 to 3; and
X^{m-} represents a m− valent counterion.

The polymers comprising the repeating unit of formula I present a good eco-toxicity profile and a better biodegradability compared to existing cationic polymers.

The polymers comprising repeating units of formula I are highly efficacious macromolecular antimicrobials, which is one first advantage, especially since the polymers comprising repeating units of formula I do not lead to production of harmful degradation byproducts being resistant to hydrolysis thanks to stable urea functionality when used for home and personal care (HPC) applications at pH different from neutral and being less detrimental to waterways and food supplies in comparison to triclosan (antimicrobial agent commonly used in HPC applications).

There are many factors that influence antimicrobial activity and selectivity of the polymers for use in those applications. Careful tuning of the antimicrobial polymers hydrophilic/hydrophobic balance (amphiphilicity) significantly impacts their activity and selectivity. This can be achieved by the appropriate choice of the polyepoxide alkylating agent to be reacted with the urea diamine compound resulting in new cationic polymers comprising repeating units of formula I.

Another subject matter of the invention is thus the preparation process of these polymers comprising a step (i) of reacting a compound of formula II:

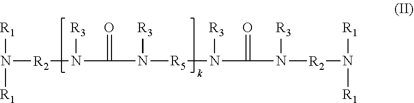

wherein
R₁ are each independently a hydrogen atom, a C₁ to C₄ alkyl or hydroxyalkyl group, or a C₂ to C₄ alkenyl group;
R₂ are each independently a C₂ to C₁₀ alkylene group;
R₃ are each independently a hydrogen atom, a C₁ to C₄ alkyl or hydroxyalkyl group, or a C₂ to C₄ alkenyl group;
R₅ represents an alkylene group, an oxyalkylene group of formula A, a cycloalkylene group, or an arylene group, optionally substituted and/or interrupted by one or more heteroatoms or heteroatom containing groups;
k represents a positive integer from 0 to 20;
with a compound of formula III:

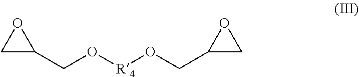

wherein
R′₄ is selected in the group consisting of
—CH₂—CH(OH)—CH₂—; —CH₂—CH(CH₂OH)—; —CH₂—CH(O—CH₂—CHO—CH₂)—CH₂—; —CH₂—CH(CH₂O—CH₂—CHO—CH₂)—; a C₃ to C₁₀ alkylene; an arylene and an oxyalkylene group of formula A:

(—CHR₇CH₂)ₐ—(OCH₂CHR₈)_{b}—(OCH₂CHR₉)_{c}—(OCH₂CHR₁₀)_{d} (A)
wherein
“a” represents 1;
“b” represents an integer of 1 or more;
“c” and “d” represent independently from one another an integer of 0 or more; and
R₇, R₃, R₉ and R₁₀ represent independently from one another a hydrogen atom or a C₁ to C₄ alkyl group;
thus leading to a polymer comprising repeating units of formula I as defined above wherein R₆═H
and optionally one or more subsequent step(s) ii) of ring opening reaction between any oxirane containing compound present in the reaction mixture and any OH or O⁻ group present on the polymer comprising repeating units of formula I as defined above;
thus leading to a polymer comprising repeating units of formula I as defined above wherein at least some R₆ groups are derived from said ring opening reaction between any oxirane containing compound present in the reaction mixture during the synthesis process of the polymer of formula I with any OH or O− group present on the polymer formula I of the invention during its synthesis.

The synthesis strategy permits to use inexpensive, commercially available raw materials. The process of the invention is a step-growth polycondensation process that gives access to modest molecular weights, enabling the polymers to be soluble/processable for subsequent potential post functionalization. Importantly, the process according to the invention is perfectly viable in bulk polymerization conditions or in highly concentrated water solutions helping to mitigate the cost, and reduce solvent waste. The process of the invention gives total conversions of the raw materials and gives possibility to eliminate polymer purification and isolation steps.

A large scope of chemistry is possible for the polymer comprising repeating units of formula I due to newly elaborated alkylating agents (e.g. polyepoxides of formula III). Without being bond by any theory, it is the inventors' understanding that the expected lower eco-toxicity of the new cationic polymers according to the invention is due to lower charge density. Indeed, it is believed that lower and fine tunable charge density of the new cationic polymers according to the invention is possible thanks to using newly applied alkylating agents being of polyepoxide nature. Another advantage of the invention is that applying the oxirane functionality as alkylating agent of the tertiary amine group permits to tune the anionic counterion of the formed quaternary ammonium group. The counterion will be formed from the acid molecules chosen for the reaction. It can be of inorganic acid origin for example hydrochloric acid, sulfuric acid, phosphoric acid or of organic acid origin for example acetic acid, citric acid, lactic acid, methyl sulfonic acid, p-toluene sulfonic acid, etc.

Another advantage of the polymers of the invention is that they can be at least partly and preferably totally bio-based and/or can be produced according to a sustainable production process. The polymers comprising repeating units of formula I may for example be prepared by reaction between urea diamine condensates and polyethylene glycol and polypropylene glycol or their copolymers bis-epoxide derivatives. Said polyethylene glycol and polypropylene glycol or their copolymers bis-epoxide derivatives are typically obtained through polymerization of ethylene oxide and propylene oxide and epichlorohydrine, that may be for example bio-based. Other bis or poly epoxide alkylating agents can be prepared from glycerol which is a largely available bio sourced raw material. Regarding urea compound, being largely used in agrochemical applications, it can be produced according to a sustainable one-step electrochemical method based on the reaction between nitrogen gas and carbon dioxide in the presence of special catalysts as described in the recent publication Chen, C., Zhu, X., Wen, X. et al. Coupling N₂ and CO₂ in H₂O to synthesize urea under ambient conditions. Nat. Chem. 12, 717-724 (2020). https://doi.org/10.1038/s41557-020-0481-9.

Another advantage of the invention is that most of the cationic polymers comprising the repeating unit of formula I can be formulated in surface treatment compositions that contain anionic surfactants. Indeed, the cationic polymers of the invention can be such that they do not precipitate with the said anionic surfactants present in the compositions and hence the intrinsic performance of the cationic polymers of the invention as well as the performance of the compositions (e.g. the cleaning performance) are not adversely affected.

Another advantage of the invention is that the cationic polymers comprising the repeating unit of formula I can be formulated in surface treatment compositions to provide soil release benefits e.g. to fabrics in laundry compositions and to hard surfaces in hard surface cleaning compositions.

Therefore, another subject matter of the invention is the use of these polymers in home and personal care applications, or in industrial and institutional cleaning applications.

A further subject matter of the invention is a formulation comprising:
(i) a polymer comprising repeating units of formula I according to the invention or obtained by the process according to the invention;
(ii) and an adjuvant selected from a surfactant and/or a thickening agent

Various specific advantages and possible embodiments of the invention will now be described in more details

### DETAILED DESCRIPTION

### Definitions

Throughout the description, including the claims, the term “comprising”, “comprising one” or “comprising a” should be understood as being synonymous with the term “comprising at least one”, unless otherwise specified. The terms “between” and “from . . . to . . . ” should be understood as being inclusive of the limits.

The articles “a”, “an” and “the” are used to refer to one or to more than one (i.e., to at least one) of the grammatical object of the article.

It should be noted that in specifying any range of concentration, molar or weight ratio or amount, any particular upper concentration, molar or weight ratio or amount can be associated with any particular lower concentration, molar or weight ratio or amount, respectively.

As used herein, the term “alkyl” means a saturated hydrocarbon radical, which may be straight, branched or cyclic, such as, methyl, ethyl, n-propyl, iso-propyl, n-butyl, sec-butyl, t-butyl, pentyl, n-hexyl, cyclohexyl.

As used herein, the terminology “Cx-Cxx” in reference to any organic group, wherein x and xx are each integers, indicates that the group may contain from x carbon atoms to xx carbon atoms per group.

As used herein, the term “hydroxyalkyl” means an alkyl radical, which is substituted with a hydroxyl groups, such as hydroxymethyl, hydroxyethyl, hydroxypropyl, and hydroxydecyl.

### Structure of the Polymer Comprising Repeating Units of Formula I

According to the repeating unit of formula I present on the polymer of the invention, it can be seen that R₆ represents a hydrogen atom or a radical being the product of the ring opening reaction between any oxirane containing compound present in the reaction mixture during the synthesis process of the polymer comprising repeating units of formula I and any OH/O− group present on the polymer formula I during its synthesis. Indeed any OH (or O⁻) group present on the polymer comprising repeating units of formula I during its synthesis can react with any oxirane function present in the reaction mixture. The resulting polymer comprising repeating units of formula I is thus branched/reticulated. This reticulation/branching is controllable via the molar ratio of the reacting urea di-amine and epoxide compounds used in the synthesis and through process conditions also (batch versus semi continuous for example). To control the branching/reticulating phenomena it is possible to play on the mole ratio of the acid molecules used during the process as well as the manner and the moment it is applied during the synthesis process. For example, molar insufficiency of the acid to oxirane groups can result in an anionic homopolymerization of the oxirane rings with polyether type branches formation.

Non-limiting examples of branching that may occur are illustrated below:

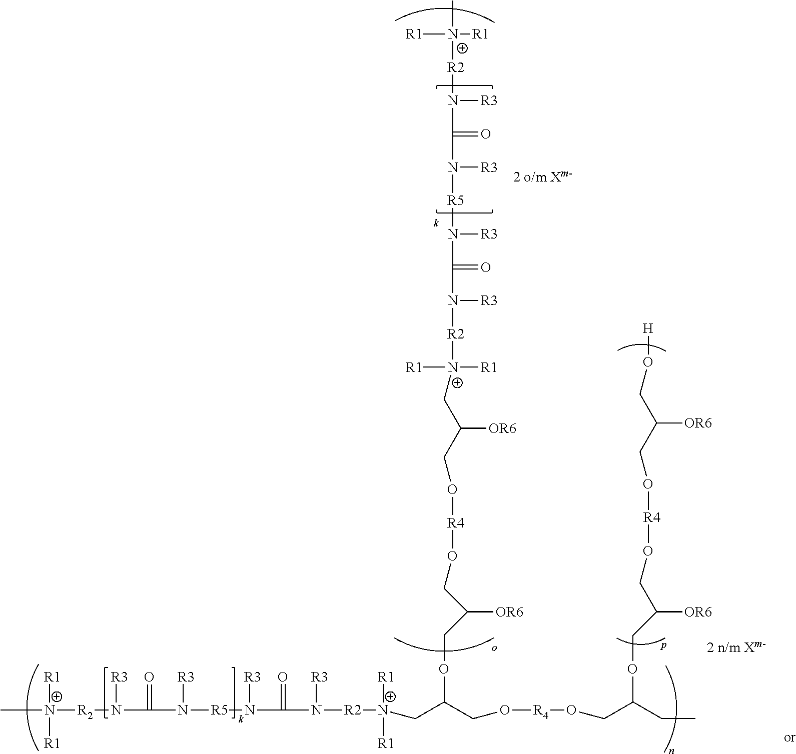

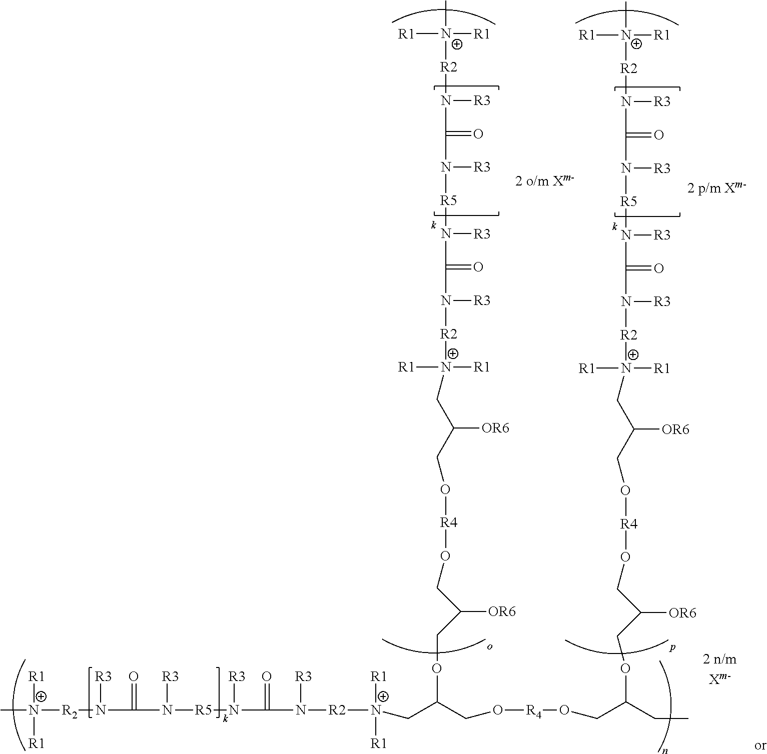

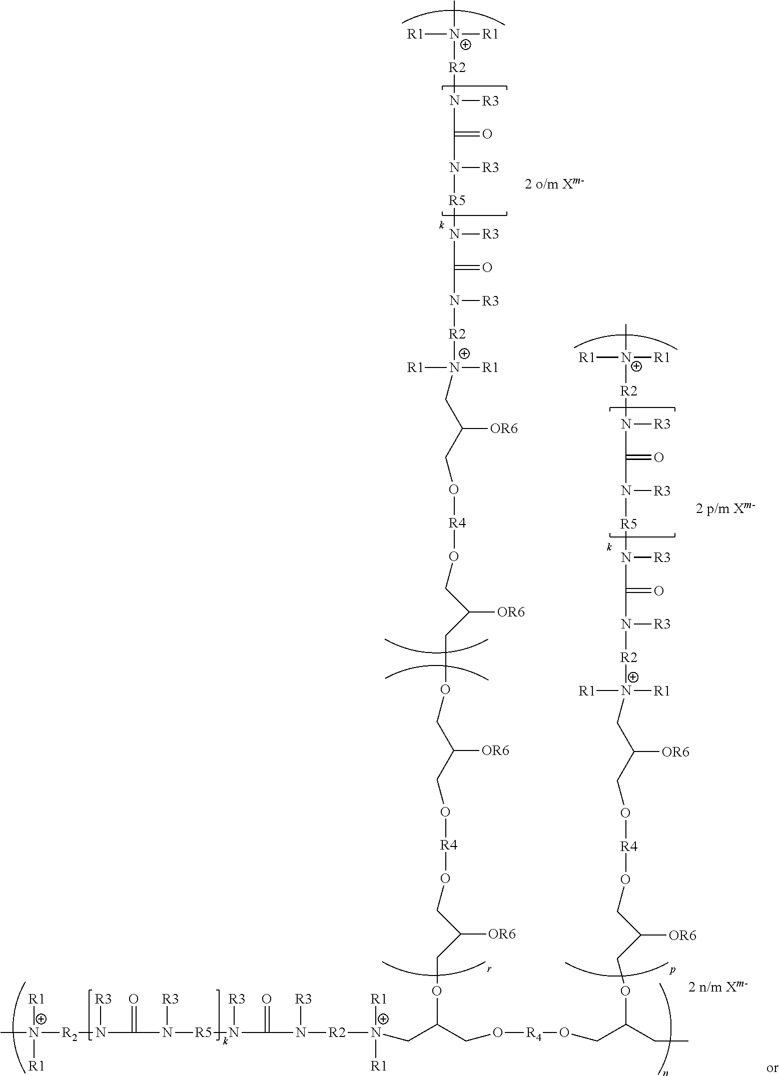

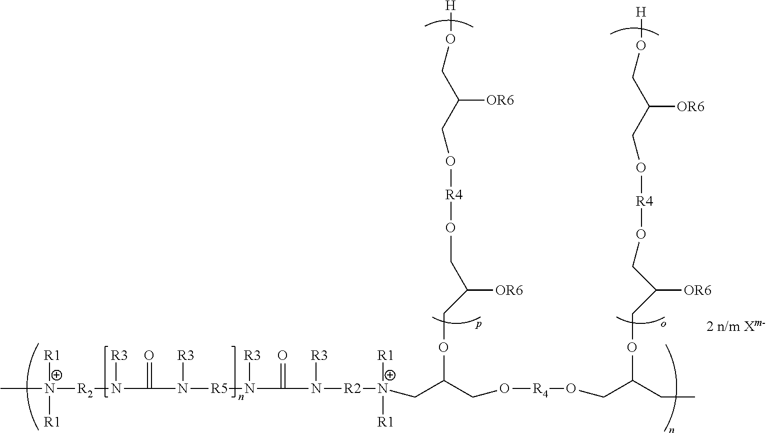

In such exemplified structures, R₁ to R₆, as well as n, k, m and X, have the same meaning as previously mentioned. o, p and r are each independently positive integers from 1 to 20.

In other words, R₆ groups can be independently either H, or a repeating unit of formula

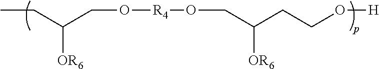

Or of formula

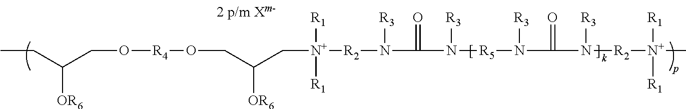

Or a combination of both above formulas.

In one embodiment of the invention, k equals zero, which means that the structure of the polymer comprising repeating units of formula I is based on monourea diamine condensates.

In another embodiment of the invention, k is greater than 1, preferably between 1 and 20, even more preferably between 1 and 15. In this embodiment, the structure of the polymer comprising repeating units of formula I is based on polyurea diamine condensates.

Whatever the value of k, the polymer according to the invention is preferably such that in formula I:
R₁ are C₁ alkyl groups, i.e methyl groups;
R₂ are C₂ or C₃ alkylene group; and
R₃ are hydrogen atoms.

In this preferred polymer, R₅ may represent a C₂ to C alkylene group or an arylene group substituted with carboxylic acid group.

For sake of clarity, the ratio 2 n/m is to provide the exact number of counterion X^{m-} necessary to reach the neutrality of the polymer comprising repeating units of formula I, wherein m is the valency of the anion and n is the number of repeating units of formula I.

According to a preferred embodiment, the polymer according to the invention is such that in formula I:
R₄ is selected in the group consisting of
—CH₂—CH(OH)—CH₂—; —CH₂—CH(CH₂OH)—; —CH₂—CH(O—CH₂—CH(OR₆)—CH₂)—CH₂—; —CH₂—CH(CH₂O—CH₂—CH(OR₆)—CH₂)—; a C₃ to C₁₀ alkylene (preferably C₄ to C₅); an arylene and an oxyalkylene group of formula A:

(—CHR₇CH₂)ₐ—(OCH₂CHR₈)_{b}—(OCH₂CHR₉)_{c}—(OCH₂CHR₁₀)_{d} (A)
wherein
“a” represents 1;
“b” represents an integer of 1 or more;
“c” and “d” represent independently from one another an integer of 0 or more; and
R₇ is methyl or hydrogen, R₃ is hydrogen, R₉ is hydrogen or methyl and R₁₀ is methyl group.

X can be any electrophilic group, which, when associated with m− is giving an anion of formula X^{m-} being a counterion of the quaternary ammonium group(s) present on the polymer comprising repeating units of formula I. The most common useful anions can derived from hydrochloric acid (X^{m-}═Cl⁻), sulfuric acid (X^{m-}═SO₄²⁻), sulfonic acid (X^{m-}═HSO₃⁻), phosphoric acid (X^{m-}═H₂PO₄⁻, HPO₄²⁻, PO₄³⁻), phosphonic acid (X^{m-}═HPO₃²⁻), any carboxylic acid as acetic acid (X^{m-}═acetate CH₃COO⁻), lactic acid (X^{m-}=lactate CH₃CH(OH)COO⁻), citric acid (X^{m-}=citrate), succinic acid (X^{m-}=succinate), maleic acid (X^{m-}=maleate), tartaric acid (X^{m-}=tartrate), benzoic acid (X^{m-}=benzoate), phtalic acid (X^{m-}=phtalate) and its isomers, organic sulfonic acids like methyl sulfonic acid (X^{m-}=methyl sulfonate), p-toluene sulfonic acid (X^{m-}═p-toluene sulfonate) and is not limited to provided examples.

Preferred X^{m-} counterions suitable for the present invention are acetate, lactates, citrates, maleates, tartrates, benzoates.

Particularly good results have been obtained with X^{m-} being an acetate.

The large choice of the anion counterion X^{m-} gives high flexibility in view of the formulation universality, the increased flexibility of the formulation with anionic surfactants, and enhanced compatibility with particular ingredients of the target formulation and improved encapsulation capability (for example of the perfumes or other active ingredients like inorganic or organic UV filters, etc). It is known also that chloride anions are corrosive to several materials thus by having the possibility to replace chloride counterion by more mild ones like lactate anions, the application scope of the new cationic polymers is significantly enlarged.

In an advantageous embodiment, the polymer according to the invention is such that, in formula I:
n represents a positive integer from 1 to 50
m is 1 and
X^{m-} is CH₃COO⁻.

It is particularly preferred that the polymer according to the invention has a weight average molecular weight ranging from 1 to 100 kg/mol, preferably 2 to 50 kg/mol.

In a specific embodiment, the polymer is characterized by a cationic charge density. The cationic charge density expressed in mmol/g is calculated as a ratio of the quantity of the moles of the amine groups in the urea di-amine compound (of formula II) and the sum of the masses of the urea di-amine compound (of formula II) with the alkylating epoxide compound (of formula III). In case of the provided examples the anion counterion was not taken into account for cationic charge density calculation. It is particularly preferred that the polymer according to the invention has a cationic charge density ranging from 0.1 to 5.4 mmol/g, preferably 0.5 to 4.8 mmol/g.

The polymer comprising repeating units of formula I, depending on the ratio of the reagents used, can be terminated with tertiary amine groups, oxirane groups, hydroxyl groups, urea groups or with halogenoalkyl groups or other groups resulting from post polymerization polymer modification reaction of the mentioned terminating groups.

### Molar Mass Determination Method

In the present patent application, unless otherwise indicated, when reference is made to molar mass (or molecular weight), it will relate to the absolute weight-average molar mass, expressed in g/mol.

The mass distribution of the polymer is measured by SEC MALS analysis (SEC: Size Exclusion Chromatography—MALS: Multi-Angle Laser Scattering) in order to obtain the real values, expressed in g/mol. Light scattering is an absolute technique, meaning that it does not depend on any calibration standards or calibration curves (M. W. Spears, The Column 12(11), 18-21 (2016)).

The SEC MALS analysis is performed with an HPLC chain equipped with 2 detectors: Differential refractometer RI—the concentration detector and MALS detector (Multi-Angle Laser Scattering)—the mass detector. The software records the chromatograms of the detectors:—one for the RI detector, and one for each angle of the MALS detector.

For each slice of the chromatograms (for the polymeric species), the software calculates: the concentration of the polymer (RI signal=constant*dn/dc*concentration) and the mass Mi of the slice.

From particular Mi data, the software calculates the mass distribution: Mw, Mn and polydispersity index lp=Mw/Mn.

The calculation of the molar masses requires the refractive index increment, dn/dc of the polymer. It is a constant, depending on the nature of the mobile phase, the temperature of the experimental conditions and the wavelength of the laser, among others. This constant can be measured according to the eluted fraction from the SEC MALS analysis with a refractometer.

For the polymers of the present patent application, “dn/dc” is calculated by the software according the mass recovery of the eluted fraction: the applied dn/dc=0.17 mL/g leads from about 90 to 100% wt. mass recovery. For examples polymers, the molar mass were calculated based on the real Mi points, without any adjustment of the log (M) curve.

Detailed Analysis conditions are as follows:
Analysis instrument: SEC system with MALS detector (Mini Dawn Heleos) and Agilent Differential Refractometer (RI)
Pump: Agilent 1100
Mobile phase: mixture of 80% water with 0.1 M NaNO₃, 200 ppm pDADMAC and 20% CH₃CN with pH=3
Column (maker, model no.): Shodex OHpak SB 806M HQ (guard column with 3 columns of 30 cm)
Temperature: 35° C.
Flow rate: 1.0 mL/min
Injection amount and Sample concentration: 100 μL, 0.1% (expressed in dry polymer)
Data processing: ASTRA 7 (Wyatt)

### Preparation of the Polymer Comprising Repeating Units of Formula I

The polymer comprising repeating units of formula I according to the invention is typically obtained by a process comprising a step (i) of reacting a compound of formula II:

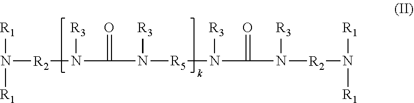

wherein
R₁ are each independently a hydrogen atom, a C₁ to C₄ alkyl or hydroxyalkyl group, or a C₂ to C₄ alkenyl group;
R₂ are each independently a C₂ to C₁₀ alkylene group;
R₃ are each independently a hydrogen atom, a C₁ to C₄ alkyl or hydroxyalkyl group, or a C₂ to C₄ alkenyl group;
R₅ represents an alkylene group, an oxyalkylene group of formula A, a cycloalkylene group, or an arylene group, optionally substituted and/or interrupted by one or more heteroatoms or heteroatom containing groups;
k represents a positive integer from 0 to 20;
with a compound of formula III:

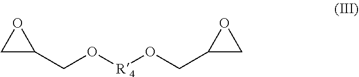

wherein
R′₄ is selected in the group consisting of
—CH₂—CH(OH)—CH₂—; —CH₂—CH(CH₂OH)—; —CH₂—CH(O—CH₂—CHO—CH₂)—CH₂—; —CH₂—CH(CH₂O—CH₂—CHO—CH₂)— and an oxyalkylene group of formula A:

(—CHR₇CH₂)ₐ—(OCH₂CHR₈)_{b}—(OCH₂CHR₉)_{c}—(OCH₂CHR₁₀)_{d} (A)
wherein
“a” represents 1;
“b” represents an integer of 1 or more;
“c” and “d” represent independently from one another an integer of 0 or more; and
R₇, R₃, R₉ and R₁₀ represent independently from one another a hydrogen atom or a C₁ to C₄ alkyl group;
thus leading to a polymer comprising repeating units of formula I as defined above wherein R₆═H;
and optionally one or more subsequent step(s) ii) of ring opening reaction between any oxirane containing compound present in the reaction mixture and any OH or O⁻ group present on the polymer comprising repeating units of formula I as defined above;
thus leading to a polymer comprising repeating units of formula I as defined above wherein at least some R₆ groups are derived from said ring opening reaction between any oxirane containing compound present in the reaction mixture during the synthesis process of the polymer of formula I with any OH or O− group present on the polymer formula I of the invention during its synthesis.
“at least some R₆” should be understood as at least one R₆ group.

The process according to the present invention is advantageously such that step i) is performed in presence of an acidic compound of formula XH, wherein X is has been defined previously. The most common useful XH are selected from: hydrochloric acid, sulfuric acid, sulfonic acid, phosphoric acid, phosphonic acid, any carboxylic acid as acetic acid, lactic acid, citric acid, succinic acid, maleic acid, tartaric acid, benzoic acid, phtalic acid and its isomers, organic sulfonic acids like methyl sulfonic acid, p-toluene sulfonic acid and is not limited to provided examples.

Preferred XH acidic compounds are lactic acid, acetic acid, citric acid, tartaric acid, maleic acid and benzoic acid.

The large choice of acidic compounds XH gives high flexibility in view of the formulation universality, the increased flexibility of the formulation with anionic surfactants, and enhanced compatibility with particular ingredients of the target formulation and improved encapsulation capability (for example of the perfumes or other active ingredients like inorganic or organic UV filters, etc). It is known also that chloride anions are corrosive to several materials thus having possibility to replace chloride counterion by more mild ones like lactate anions the application scope of the new cationic polymers is significantly enlarged.
Step i) of the process of the invention is advantageously carried out with a molar ratio between the compound of formula II and the compound of formula III that is ranging from 0.5 to 2.2.
Step i) of the process of the invention is advantageously carried out with a molar ratio between the compound of formula II and the compound of formula III that is ranging from 0.5 to 1.5, preferably from 0.75 to 1.25 and more preferably from 0.9 to 1.1.

In the process of the invention, step i) may also be performed in presence of a further alkylating agent (in addition of the compound of formula III), like any dihalogenoalkyl ether compound, including but not limited to commercial ones like dichloro ethyl ether.

In a specific embodiment of the process of the invention, the compound of formula II is prepared by reaction of:
a diamine of formula IV:

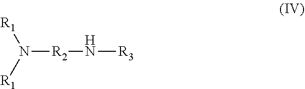

wherein R₁, R₂ and R₃ are as defined above;
and optionally with a diamine of formula IV′:

H₂N—R₅—NH₂ (IV′)
wherein R₅ is as defined above;
with urea of formula V NH₂CONH₂ (V);
in a molar ratio IV:V:IV′ from 2:1:0 to 0.4:1:0.8.

The higher the rate of the compound IV′ used for the reaction the longer polyurea chain is formed. The upper limit of the rate of the compound IV′ depends on its chemical nature. When targeting a polyurea based compound, the goal is to obtain the polyurea compound being liquid at reaction temperature and soluble or dispersible in solvent preferably water at room temperature.

When there is no diamine of formula IV′ used in the preparation process of the compound of formula II, meaning that the compound of formula II is a monourea diamine condensate, the molar ratio IV:V ranges from 1.5 to 2.25, preferably from 1.75 to 2.1 and more preferably from 1.95 to 2.05 mol of the compound IV to 1 mol of compound V.

When there is some diamine of formula IV′ used in the preparation process of the compound of formula II, meaning that the compound of formula II is a polyurea diamine condensate, the molar ratio of IV′:V is maximum 0.8 (from 0.05 to 0.8) and the remaining molar amount of diamine (up to 1) is completed by the diamine of formula IV, which, as it is mono-functional, has to be doubled and then the molar ratio of compound of formula IV is minimum 0.4 (from 0.4 to 1.9).

It is particularly preferred that the compound of formula IV is dimethylaminopropylamine (DMAPA), meaning that R₁ are both methyl groups, R₂ is —(CH₂)₃— and R₃ is hydrogen.

Examples of diamine of formula IV′ are ethylene diamine, propylene diamine, hexamethylene diamine, Isophorone diamine, Diaminobenzoic acid and is not limited to the provided examples.

When R₅ represents an oxyalkylene group of formula A, the diamine of formula IV′ can be a Jeffamine type compound, i.e. in particular, such a Jeffamine can be selected among the Jeffamine-diamines as available from Huntsman Company that are for example Jeffamine ED-600, ED-900, ED-2003, EDR, D-230, D-400, D-2000).

The very preferred IV′ are ethylene diamine and diaminobenzoic acid.

In a preferred process according to the invention, the compound of formula III is such that R′₄ is selected in the group consisting of:
—CH₂—CH(OH)—CH₂—; —CH₂—CH(CH₂OH)—; —CH₂—CH(O—CH₂—CHO—CH₂)—CH₂—; —CH₂—CH(CH₂O—CH₂—CHO—CH₂)—; a C₃ to C₁₀ alkylene (preferably C₄ or C₅); an arylene and an oxyalkylene group of formula A:

(—CHR₇CH₂)ₐ—(OCH₂CHR₈)_{b}—(OCH₂CHR₉)_{c}—(OCH₂CHR₁₀)_{d} (A)
wherein
“a” represents 1;
“b” represents, an integer of 1 or more, preferably up to 70;
“c” and “d” represent independently from one another an integer of 0 or more, preferably up to 70; and
R₇ is methyl or hydrogen, R₃ is hydrogen, R₉ is hydrogen or methyl and R₁₀ is methyl group.

Thus R₄′ groups can be derived from polyethylene glycol with preferred Mn being in the range of approximately from 100 to 3000 g/mol, and from polypropylene glycol with preferred Mn being in the range of approximately from 100 to 3000 g/mol, and from poly(ethylene/propylene) glycol copolymers random and block nature with preferred Mn being in the range of approximately from 100 to 3000 g/mol, and from poly(propylene-co-ethylene-co-propylene) glycol multi block copolymers with preferred Mn being in the range of approximately from 150 to 3000 g/mol, and from poly(ethylene-co-propylene-co-ethylene) glycol multi block copolymers with preferred Mn being in the range of approximately from 150 to 3000 g/mol.

Examples of compounds of formula III are glycerol diglycidyl ether (for example from Aldrich) and Glycerol polyglycidyl ether (grade EX313 from Denacol company), Poly(propylene glycol) diglycidyl ether Mn-400 g/mol (for example from Aldrich and grade EX920 from Denacol company and Poly(ethylene glycol) diglycidyl ether Mn-500 g/mol (for example from Aldrich or grade DER736 from Dow company).

### Example of Process Conditions

In the process of the invention, the compound of formula I is generally synthetized in standard reactor equipped with temperature control heating system, a lid containing multiple entries with installed a reflux system, a mechanical stirring system, a nitrogen purge line and a raw materials feed line. A stream of nitrogen is usually introduced into the reactor to prevent the oxidation of the reaction mixture and its discoloration. The synthesis is generally done in water solvent to achieve the final product solid content of about 30%-70%. The mono or polyurea di-amine compound can be placed in batch manner into the reactor as initial charge. The acidic compound XH is preferably added in batch manner into the reactor as initial charge. Adequate alkylating agent (ex. Di-epoxide compound) is preferably introduced in semi-continuous manner to better control the exothermic effect of the reaction and to limit the branching reactions. The reaction is usually done under efficient stirring and under atmospheric pressure. The reaction temperature can range from 40° C. to 100° C., preferred 60° C. Typical reaction time is around 8 to 12 hours. The reaction product is generally a limpid to hazy viscous liquid.

In the process of the invention, the compound of formula II is generally synthetized in the standard reactor equipped with temperature control heating system, a lid containing multiple entries with installed a reflux system prolonged with the ammonia recovery line, a mechanical stirring system, a nitrogen purge line, a raw materials feed line and a recovery flask to collect eventual amine condensates carried away with ammonia gas. A stream of nitrogen can be used to prevent the oxidation of the reaction mixture and its discoloration. The reagents are usually introduced into the reactor at batch manner at the beginning of the process, without any solvent. Stirring and heating are preferably maintained for around 10-15 hours at atmospheric pressure. At this step, the reaction is typically done at 2 temperatures, at the begging at around 110-130° C., then 145° C.-155° C. During all heating time the ammonia can be trapped in water flasks. When no more ammonia flow is observed the assembly can be placed under vacuum at around 350-550 mmHg at 145-155° C. for around 2 hours to recover the remaining in the reactor ammonia and not reacted di-amine raw materials. The vacuum can be then broken and the assembly can be cooled to ambient temperature. The product is typically liquid at room temperature.

### Uses of the Polymer Comprising Repeating Units of Formula I

The polymer comprising repeating units of formula I of the present invention is usable in many surface treatment applications, notably in home and personal care applications (fabrics, hair, hard surfaces, toilets, etc.)), but also in Industrial applications like lubricant for metal treatment, or binder between metal and organic coatings.

Other uses of the polymer comprising the repeating unit of formula I are agrochemical formulations and coatings formulations.

In particular, the present invention is targeting the use of the polymer according to the invention, as anti-microbial agent in:
a. laundry compositions, including but not limited to:
   i. laundry detergent compositions;
   ii. rinse-added laundry compositions such as fabric softener, laundry
sanitizer;
   iii. ancillary laundry compositions;
   iv. fabric care compositions such as fabric freshener, fabric spray
b. hard surface cleaning compositions, including but not limited to:
   i. floor cleaning compositions
   ii. toilet or bathroom cleaning compositions
   iii. toilet bowl cleaning compositions
c. dish wash cleaning compositions such as hand dish wash and automatic dish wash compositions.
d. hair care compositions such as shampoo and conditioning compositions.

By “anti-microbial agent” it is understood that it is an agent that capable of killing or inhibiting the growth of microorganisms.

By “Ancillary laundry compositions”, it is understood that it means compositions intended to be used in addition to the consumer's regular laundry products (laundry detergent, softener). For example in addition to a wash detergent and/or rinse added fabric conditioners. The ancillary laundry composition may be added into the wash liquor at any point in the wash cycle.

The present invention is also directed to the use of the polymer according to the invention, as dye fixing agent or transfer inhibitor agent or soil anti-redeposition agent or soil release agent or laundry additives deposition agent in laundry compositions. In case of laundry additive deposition agent, the laundry additive can be for example a fabric care polymer, a fragrance oil, or an encapsulated perfume.

Also, the present invention is directed to the use of the polymer according to the invention, as soil anti-redeposition agent or soil release agent or shining agent in dish wash compositions.

### Formulations Comprising the Polymer Comprising Repeating Units of Formula I

The present invention is also directed to a formulation comprising:
(i) a polymer as defined above or obtained by the process as defined above,
(ii) and an adjuvant selected from a surfactant and/or a thickening agent.

Indeed, as explained previously, the formulation of the present disclosure comprising the polymer comprising repeating units of formula I is suitable for a variety of consumer applications.

In one embodiment of the present disclosure, the formulation is a homecare formation or personal care formulation. Examples of the formulations of the invention include, but are not limited to, surface cleaners such as those intended for use in bathrooms, kitchens, living areas, hard floor cleaners, carpet cleaners, furniture cleaners, glass/mirror cleaners; toilet care products including solid toilet cleaners such as rim devices and those designed to be placed in the cistern, liquid toilet cleaners excluding those comprising hypochlorite bleaches; dishwashing products such as washing up liquids and preparations from dishwashing machines such as dishwashing solids (e.g. powders and tablets) & liquids; laundry products such as solid detergents (e.g. powders and tablets), liquid detergents and fabric conditioners and “2 in 1” products comprising detergent and fabric conditioner; cleaning products intended for use outdoors such as those for cleaning for wood, stone, concrete or plastics, for example patio cleaner, garden furniture cleaners/treatments, BBQ cleaners, wall and fence cleaners/treatments, plant sprays such as those intended to remove insects such as aphides from plants; food sprays, such as those suitable for use in food preservation; personal care products such as bath and shower products; soaps, including liquid and solid soaps, hand sanitizers, deodorants and antiperspirants, haircare products including shampoos, for example anti-scalp odour shampoos, shampoos for the control of head lice eggs and anti-dandruff shampoos, hair conditioners, hair styling products such as hair mousses, gels and sprays, skin care products such as shaving products, cosmetics and products for hair removal; baby products including baby cleaning and cleansing products such as baby bath, soaps, wipes, moisturizers, nappy rash cream, products for cleaning surfaces that have regular & high incidence of infant & baby contact; first aid products and products for treating ailments and illnesses, including products for the topical treatment and/or prevention of minor infections such as athletes foot, spot/acne prevention/treatment products; foot hygiene products, including those for use on the foot and those for the treatment/deodorization of foot ware, particularly sports foot wear; products for cleaning and/or deodorizing vehicles such as cars.

In one aspect of the present disclosure, the formulation is a laundry detergent composition, comprising:
i) the polymer comprising repeating units of formula I as illustrated above; and
ii) a surfactant that can be selected from cationic surfactant, anionic surfactant, non-ionic surfactant, amphoteric surfactant or the combination thereof.

The laundry detergent composition can be in a form of liquid or solid.

Suitable non-ionic surfactants for use as the formulation surfactant include but are not limited to ethylene oxide/propylene oxide block polymers, polyethoxylated sorbitan esters, fatty esters of sorbitan, ethoxylated fatty esters (containing from 1 to 25 units of ethylene oxide), polyethoxylated C₈-C₂₂ alcohols (containing from 1 to 25 units of ethylene oxide), polyethyoxylated C₆-C₂₂ alkylphenols (containing from 5 to 25 units of ethylene oxide), alkylpolyglycosides. Examples include but are not limited to nonyl phenol ethoxylate (9EO), Nonyl phenol ethoxylate (2EO), octyl phenol ethoxylate (10EO), C₁₂/C₁₄ synthetic ethoxylate (8EO), stearyl alcohol ethoxylate (7EO), cetostearyl alcohol ethoxylate (20EO), coconut fatty amine ethoxylate (10EO), sorbitan monolaurate ethoxylate, 80% PO/20% EO, coconut diethanolamide (shampoo foam booster), sorbitan monolaurate, sorbitan monolaurate 4EO, di-isopropyl adipate, alkyl poly glucosides, such as C₆₋₂₀, preferably C₃₋₁₀alkyl glucosides, eg Surfac APG (D-Glucopyranose oligomers C₈₋₁₀ alkyl glucosides, CAS 161074-97-1, available from Seppic, UK), and cetostearyl stearate. Other suitable non-ionic surfactants include Neodol 25-7 (C_{12/15} alcohol 7 ethoxylate (EO), CAS 68131-39-5), Surfac LM90/85 (C_{12/15} alcohol 9 ethoxylate (EO), CAS 68131-39-5), Surfac 65/95 (C9/11 alcohol 6.5 ethoxylate (EO), CAS 68439-45-2), Tomadol PF9 (C9/11 alcohol 6.0 ethoxylate (EO), CAS 68439-46-3), Surfac T80 Veg (Polysorbate 80, Polyoxyethylene sorbate mono oleate, CAS 9005-65-6), Tween 60 (Polysorbate 60, Polyoxyethylene sorbate mono stearate, CAS 9005-67-8), Tween 40 (Polysorbate 40, Polyoxyethylene sorbate mono palmitate, CAS 9005-66-7), Surfac T-20 (Polysorbate 20, Polyoxyethylene sorbate mono laurate, CAS 9005-64-5), Surfac PGHC (Hydrogenated Castor oil 40EO, CAS 61788-85-0), Ninol 49-CE (Coconut diethanolamide, CAS 68603-42-9).

The anionic surfactants contemplated in the present disclosure as surface-active agent comprise the major active components in conventional detergent systems, including any of the known hydrophobes attached to a carboxylate, sulphonate, sulfate or phosphate polar, solubilizing group including salts. Salts may be the sodium, potassium, ammonium and amine salts of such surfactants. Useful anionic surface-active agents can be organic sulfuric reaction products having in their molecular structure an alkyl group containing from about 8 to about 22 carbon atoms and a sulfonic acid or sulfuric acid ester group, or mixtures thereof. (Included in the term “alkyl” is the alkyl portion of acyl groups.) Examples of this group of synthetic detersive surfactants which can be used in the present disclosure are the alkyl sulfates, especially those obtained by sulfating the higher alcohols (C₈-C₁₈ carbon atoms) produced from the glycerides of tallow or coconut oil; and alkyl benzene sulphonates.

Other useful anionic surface-active agents herein include the esters of alpha-sulphonated fatty acids preferably containing from about 6 to 20 carbon atoms in the ester group; 2-acyloxyalkane-1-sulfonic acids preferably containing from about 2 to 9 carbon atoms in the acyl group and from about 9 to about 23 carbon atoms in the alkane moiety; alkyl ether sulfates preferably containing from about 10 to 20 carbon atoms in the alkyl group and from about 1 to 30 moles of ethylene oxide; olefin sulphonates preferably containing from about 12 to 24 carbon atoms; and beta-alkyloxy alkane sulphonates preferably containing from about 1 to 3 carbon atoms in the alkyl group and from about 8 to 20 carbon atoms in the alkane moiety.

Specific preferred anionics for use herein include: the linear C₁₀-C₁₄ alkyl benzene sulphonates (LAS); the branched C₁₀-C₁₄ alkyl benzene sulphonates (ABS); the tallow alkyl sulfates, the coconut alkyl glyceryl ether sulphonates; the sulfated condensation products of mixed C₁₀-C₁₈ tallow alcohols with from about 1 to about 14 moles of ethylene oxide; and the mixtures of higher fatty acids containing from 10 to 18 carbon atoms.

It is to be recognized that any of the foregoing anionic surfactants can be used separately herein or as mixtures. Moreover, commercial grades of the surfactants can contain non-interfering components which are processing by-products. For example, commercial alkaryl sulphonates, preferably C₁₀-C₁₄, can comprise alkyl benzene sulphonates, alkyl toluene sulphonates, alkyl naphthalene sulphonates and alkyl poly-benzenoid sulphonates. Such materials and mixtures thereof are fully contemplated for use herein.

In another aspect of the present disclosure, the formulation is a sanitizer composition, comprising:
i) the polymer comprising repeating units of formula I as illustrated above; and
ii) a thickening agent.

Preferred thickening agents used in the formulation of the present disclosure are commercially available fully synthetic thickeners based on acrylic acid copolymers, methacrylic acid copolymers, vinyl polymers, polycarboxylic acids, polyimines, polyamides and polyethers. In addition, natural thickening agents such as guars, carboxymethylcelluloses, cellulose ethers, xanthans, locust bean gum may be used, which are optionally modified by suitable chemical reactions, possibly even in view of their specific use in connection with the present disclosure. The foregoing components may be used either alone or in combinations thereof.

Illustrative examples of commercially available thickeners is a polymeric thickening agent sold under the name Jaguar HP105, distributed by Solvay.

In yet another aspect of the present disclosure, it is provided the use of the polymer comprising repeating units of formula I or a formulation comprising it, as illustrated above, for substantially reducing or controlling the formation of microbial colonies on or at the surface.

In still another aspect of the present disclosure, it is provided the use of the polymer comprising repeating units of formula I or a formulation comprising it, as illustrated above, for controlling malodor.

The following examples illustrate the invention.

### EXAMPLES

### A. Raw Materials

Table 1 below shows the reagents used in the examples and its abbreviations. All reagents used were purchased from Sigma Aldrich.

TABLE 1
Raw materials used in the experimental part for synthesis purposes.

| Product | Abbreviation | CAS |
|---|---|---|
| Urea | — | 57-13-6 |
| Hexamethylenediamine | HMDA | 124-09-3 |
| Dimethylaminopropylamine | DMAPA | 109-55-7 |
| Diaminopropane | DAP | 109-76-2 |
| Ethylenediamine | EDA | 107-15-3 |
| Bis(chloroethyl) ether | DCE1 | 111-44-4 |
| Diglycidyl ether Glycerol | DGEG | 27043-36-3 |
| Poly(propylene glycol) diglycidyl ether 380 | PPGDE | 26142-30-3 |
| Poly(ethylene glycol) diglycidyl ether 500 | PEGDE | 26403-72-5 |
| Polyquaternium-2 polymer | PQ-2 | 68555-36-5 |

For comparison aspects the “Polyquaternium-2” polymer can be obtained from Aldrich being the cationic polymer of a Monourea di-amine compound with DCE1 di-chloro alkylating agent.

### B. Mono Urea Di-Amine and Polyurea Compounds Synthesis

The Mono urea di-amine and Polyurea di-amine compounds were synthetized according to the same process. The whole synthesis is conducted in the reactor equipped with temperature control heating system, a lid containing multiple entries with installed a reflux system prolonged with the ammonia recovery line, a mechanical stirring system, a nitrogen purge line and a raw materials feed line. The ammonia recovery line is composed of two flasks where ammonia is trapped thanks to purging through the water. The water quantity applied corresponds to 10% wt. of ammonia concentration based on total consumption of the urea during the reaction. Another, empty recovery flask was placed between a reflux column at the outlet of the reactor and the water flask to collect eventual amine condensates carried away with ammonia gas.

To synthetize the mono urea di-amine compound the primary/tertiary amine being DMAPA was used.

In case of the Polyurea di-amine compound the mixture of the primary/tertiary amine being DMAPA with di primary amine being either HMDA, DAP or EDA were used. These di primary amine compounds build the repeating urea blocks of the formed polyurea di-amine macro compound.

The molar ratios of the reagents in case of the particular examples are provided in table 2. The quantities of the reagents used for the particular examples are provided in table 3.

The applied ratio of urea to amine compounds was equal to one. This ratio concerns the reacting functionalities of the urea with particular amines compounds. Thus, the molar ratio between urea, di-primary amine compound (HMDA, DAP, EDA) and DMAPA noted respectively as x:y:z was kept to respect the equation x=y+z/2. In provided examples the di primary amine molar ratio was selected at the manner to obtain a liquid product at reaction temperature (˜120-150° C.) and being soluble at room temperature in water. It was stated that for high input of the di primary amine compound in the reaction mixture, the fast solidification of the reaction mixture at given reaction temperature can occur often leading to the non-water soluble polyurea compound.

TABLE 2
Molar ratio of reagents used for mono urea di-amine
and polyurea di-amine compounds synthesis.

| Mono urea and polyurea | Urea | DMAPA | DAP | HMDA | EDA |
|---|---|---|---|---|---|
| di-amine compound | x | z | y | y | y |
| Example 1 | 1 | 2 | — | — | — |
| Example 2 | 1 | 1.8 | — | 0.1 | — |
| Example 3 | 1 | 1 | 0.5 | — | — |
| Example 4 | 1 | 0.8 | — | — | 0.6 |
| Example 4 A | 1 | 1.1 | — | — | 0.45 |

TABLE 3
Reagents quantities used for mono urea di-amine
and polyurea di-amine compounds synthesis

| Mono urea and | | | | | |
|---|---|---|---|---|---|
| polyurea di-amine | Urea, | DMAPA, | DAP, | HMDA, | EDA, |
| compound | grams | grams | grams | grams | grams |
| Example 1 | 25.25 | 85.6 | — | — | — |
| Example 2 | 26.3 | 80.7 | — | 5.0 | — |
| Example 3 | 35.25 | 60.0 | 21.75 | — | — |
| Example 4 | 40.2 | 54.7 | — | — | 24.1 |
| Example 4 A | 120.5 | 225.3 | — | — | 54.2 |

The general synthesis protocol of the mono urea and polyurea di-amine compounds was as following:

A stream of nitrogen was introduced into the reactor to prevent the oxidation of the reaction mixture and its discoloration. The appropriate weighted quantities of the di-amine compound(s) is (are) introduced into the reactor. Preheat of the reactor can be necessary if the di-amine compound has to be melted before the mechanical stirring is started. Then the appropriate weighted quantities of the Urea and primary/tertiary amine are introduced into the reactor.

Stirring and heating are maintained for around 11 hours. The reaction is done at 2 temperatures, at the begging during first 7 hours the temperature is maintained at around 120° C., than during next 4 hours at around 145° C.-150° C. During all heating time the ammonia purge is observed at trapping water flasks.

After 11 hours of the reaction at atmospheric pressure, the assembly is placed under vacuum at around 450 mmHg at 145-150° C. for 2 hours to recover the remaining in the reactor ammonia and not reacted di-amine raw materials. The vacuum is then broken and the assembly is cooled to ambient temperature.

If the product is not sufficiently liquid, it can be diluted with solvent (preferably water) to target concentration.

Finally, the contents of the ammonia trapping flasks, of the di-amines recovery flask and of the reactor are collected separately in order to be analyzed.

The reaction yields provided in table 4 were calculated from water ammonia solutions amine number titration data (solutions recovered from ammonia trapping flasks). The Amine number (AN) titration is done by diluting of 0.2 to 0.3 gram of sample in 50 mL of acetic acid and titrating it against 0.1 M perchloric acid. The number of moles of perchloric acid needed to achieve the equivalency point corresponds to number of moles of the ammonia in the test sample. To calculate the reaction yield, the titrated formed during reaction ammonia is compared to overall theoretical ammonia quantity possible to be formed from applied for reaction urea quantity.

TABLE 4
Reaction yield data and product appearance for particular
synthesis examples. The Equivalent Molecular Weight
(EMW) of the obtained mono urea and polyurea compounds
was calculated from Amine number titration data of
the final reaction mixture according to equation 1.

| | Formed NH₃, | | |
|---|---|---|---|
| Mono urea and | grams - based | Reaction yield | |
| polyurea di- | on titration | based on NH₃ | Product form at |
| amine compound | analysis | titration data, % | room temperature |
| Example 1 | 13.7 | 96% | Yellowish viscous |
| | | | liquid |
| Example 2 | 14.2 | 95% | White wax like, |
| | | | soluble in water |
| Example 3 | 19.5 | 98% | White wax like, |
| | | | soluble in water |
| Example 4 | 20.6 | 100% | White wax like, |
| | | | soluble in hot |
| | | | water |
| Example 4 A | 66.2 | 97% | White wax like, |
| | | | soluble in water |

$$E M W = 56100 ( mg KOH / mol ) / A N 1 ( mg KOH / g ) . \qquad Equation l :$$

The Amine number (AN1) titration is done according to the method described above.

The number of moles of perchloric acid needed to achieve the equivalency point corresponds to number of moles of the amine functionalities in the test sample. The Amine number is expressed in mg KOH/g of sample. Table 5 regroups the obtained data for particular synthesis examples.

TABLE 5
Amine number (AN1) and Equivalent Molecular Weight (EMW)
data obtained for particular synthesis examples.

| Polymer | AN1 (mg KOH/g) | EMW (g/mol) |
|---|---|---|
| Example 1 | 490.4 | 114.4 |
| Example 2 | 471.9 | 118.9 |
| Example 3 | 273.1 | 205.4 |
| Example 4 | 284.5 | 197.2 |
| Example 4 A | 418.7 | 134.0 |

### C. Cationic Polymers Based on Epoxide Compounds Synthesis Protocols

All cationic polymers based on epoxide compounds were synthetized according to the same process. The whole synthesis is conducted in the reactor equipped with temperature control heating system, a lid containing multiple entries with installed a reflux system, a mechanical stirring system, a nitrogen purge line and a raw materials feed line.

A stream of nitrogen was introduced into the reactor to prevent the oxidation of the reaction mixture and its discoloration.

The weighted then diluted with water to about 35%-50% concentration mono urea or polyurea di-amine compound was placed into the reactor. To the reaction mixture was further added the appropriate quantity of acetic acid. Adequate epoxide alkylating agent (DGEG and/or PPGDE) was (were) weighted and transferred to syringe type feeding pump. The initial reactor content was heated to 60° C. and reaction mixture was stirred during all the synthesis process. During the first 4 hours of the heating the epoxide agent was added semi-continuously using a syringe type pump. The exothermic effect was controlled by cryothermostat type bath. After 8 hours of heating at 60° C. the reaction mixture was cooled down to room temperature and the product was analyzed to determine residual epoxide compounds (NMR analysis), residual mono urea (HPLC analysis) and polyurea compounds (NMR analysis), Solid Content, pH, Brookfield viscosity and amine number (AN).

The molar ratio and quantities of the reagents (calculations according to EMW which takes into account the number of reactive groups in the particular reagent) used for the particular cationic polymers synthesis examples based on mono urea di-amine and polyurea di-amine compounds with various epoxide compounds are provided in the tables 6 and 7 respectively. The table 6 provides also theoretical cationic charge density data of the target polymers (calculations do not take into account the counterion of the acetic acid origin)

The obtained products analysis characteristics are provided in table 8.

TABLE 6
Examples of the molar ratio of the reagents used for cationic polymers synthesis
based on mono urea di-amine and polyurea di-amine compounds with various epoxide
compounds and theoretical cationic charge density data of the target polymers

| | | | | | | Cationic |
|---|---|---|---|---|---|---|
| | | | | | | charge |
| Cationic | Reagent 1 | | Reagent 2 | | Acetic Acid | density; |
| polymer | Type | Mol ratio | Type | Mol ratio | Mol ratio | mmol/g |
| Example 5 | Mono urea di-amine | 1 | DGEG | 1.2 | 2 | 4.2 |
| | (Example 1) | | | | | |
| Example 6 | Mono urea di-amine | 1 | DGEG | 0.5 | 2 | 3.8 |
| | (Example 1) | | PPGDE | 0.5 | | |
| Example 7 | Mono urea di-amine | 1 | PPGDE | 1 | 2 | 3.3 |
| | (Example 1) | | | | | |
| Example 8 | Mono urea di-amine | 1 | DGEG | 0.25 | 2 | 3.5 |
| | (Example 1) | | PPGDE | 0.75 | | |
| Example 9 | Mono urea di-amine | 1 | DGEG | 0.75 | 2 | 4.2 |
| | (Example 1) | | PPGDE | 0.25 | | |
| Example 10 | Mono urea di-amine | 1 | DGEG | 1 | 1.5 | 4.6 |
| | (Example 1) | | | | | |
| Example 11 | Polyurea di-amine | 1.4 | DGEG | 1 | 6 | 3.2 |
| | (Example 4) | | | | | |
| Example 21 | Polyurea di-amine | 2.2 | DGEG | 1 | 2 | 2.5 |
| | (Example 4 A) | | | | | |
| Example 22 | Polyurea di-amine | 2.2 | PPGDE | 1 | 2 | 2.1 |
| | (Example 4 A) | | | | | |
| Example 23 | Polyurea di-amine | 2.2 | PEGDE | 1 | 2 | 1.8 |
| | (Example 4 A) | | | | | |
| Example 24 | Polyurea di-amine | 2.2 | DGEG | 0.5 | 2 | 1.9 |
| | (Example 4 A) | | PPGDE | 0.5 | | |

TABLE 7
Reagents quantities used for cationic polymers synthesis based on mono urea
di-amine and polyurea di-amine compounds with various epoxide compounds.

| Cationic | | | Acetic Acid, | Water, |
|---|---|---|---|---|
| polymer | Reagent 1, grams | Reagent 2, grams | grams | grams |
| Example 5 | Mono urea di-amine | DGEG = 169.2 | 82.4 | 337.0 |
| | (Example 1) = 159.7 | | | |
| Example 6 | Mono urea di-amine | DGEG = 58.4 | 68.6 | 300.0 |
| | (Example 1) = 133.0 | PPGDE = 108.7 | | |
| Example 7 | Mono urea di-amine | PPGDE = 93.1 | 23.4 | 150.0 |
| | (Example 1) = 56.9 | | | |
| Example 8 | Mono urea di-amine | DGEG = 13.5 | 31.7 | 150.0 |
| | (Example 1) = 61.3 | PPGDE = 75.2 | | |
| Example 9 | Mono urea di-amine | DGEG = 47.8 | 37.5 | 150.0 |
| | (Example 1) = 72.6 | PPGDE = 29.7 | | |
| Example 10 | Mono urea di-amine | DGEG = 70.2 | 30.9 | 150.0 |
| | (Example 1) = 79.9 | | | |
| Example 11 | Polyurea di-amine | DGEG = 15.1 | 20.3 | 123.0 |
| | (Example 4) = 31.8 | | | |
| Example 21 | Polyurea di-amine | DGEG = 16.6 | 9.7 | 75.8 |
| | (Example 4 A) = 48.4 | | | |
| Example 22 | Polyurea di-amine | PPGDE = 25.3 | 8.0 | 73.8 |
| | (Example 4 A) = 39.7 | | | |
| Example 23 | Polyurea di-amine | PEGDE = 29.7 | 7.1 | 72.9 |
| | (Example 4 A) = 35.3 | | | |
| Example 24 | Polyurea di-amine | DGEG = 11.5 | 13.5 | 115 |
| | (Example 4 A) = 67.1 | PPGDE = 21.4 | | |

TABLE 8
Characteristics examples of the final cationic polymers based on mono urea
di-amine and polyurea di-amine compounds with various epoxide compounds

| | | Residual | | | | | |
|---|---|---|---|---|---|---|---|
| | | Mono and | Amine | Solid | Viscosity, | | |
| | Residual | polyurea | Number | Content, % | cP | | Mw |
| | epoxide | di-amine | AN, | (Gravimetric, | 20° C., 30 | pH | (SEC |
| Cationic | compound | compound | mgKOH/g | 1 gram, 1 | rpm, | (solution | MALS) |
| polymer | (¹³C NMR) | (¹H NMR) | (titration) | hour, 115° C.) | RV#3 | as is) | kDa |
| Example 5 | <1% | 1.7% | 106 | 52.9% | 620 | 7.9 | 25 |
| Example 6 | <1% | 1.3% | 95 | 52.3% | 225 | 8.5 | 4.9 |
| Example 7 | <1% | 1.0% | 88 | 53.9% | 170 | 9.5 | |
| Example 8 | <1% | 1.9% | 84 | 52.4% | 180 | 8.9 | |
| Example 9 | <1% | 4.1% | 106 | 55.2% | 260 | 9.0 | |
| Example 10 | <1% | 4.8% | 121 | 55.4% | 1420 | 10.1 | |
| Example 11 | <1% | 5% | 63 | 35.0% | 60 | 4.0 | 2.8 |
| Example 21 | <1% | 3.8% | 122 | 45% | 66 | 8.0 | |
| Example 22 | <1% | 2.7% | 106 | 46% | 63 | 7.7 | |
| Example 23 | <1% | 2.9% | 97 | 48% | 74 | 8.2 | |
| Example 24 | <1% | 3.4% | 134 | 59% | 300 | 7.9 | |

### D. Soil Anti-Redeposition Performance Test in Laundry Composition.

### D1. First Anti-Redeposition Trial

A soil anti-redeposition performance was evaluated using a clay-peanut butter soil. The soil was prepared by mixing 25% (wt/wt) of standard clay from WFK (Testgewebe GmbH) with 5% (wt/wt) peanut butter from supermarket e.g. Skippy brand and 70% mineral oil from Aldrich. The mixture was blended well with an overhead stirrer for 30 minutes to obtain homogenous mixture.

The liquid detergent base composition to prepare the laundry detergent compositions for the test is given in Table 9 below.

TABLE 9
Liquid detergent base with 10% hole*.

| | Part by |
|---|---|
| Composition | weight |
| Linear alkyl benzene sulfonic acid, C₁₀₋₁₆ | 20.0 |
| Ethoxylated fatty alcohol C₁₂₋₁₈ (7 EO units) | 20.0 |
| Lauric acid | 10.0 |
| Sodium laureth sulphate (2 EO units) | 10.0 |
| Monoethanolamine | 8.0 |
| Water | 5.0 |
| Glycerol | 5.0 |
| Propylene glycol | 12 |
| Hole* | 10 |

*comprising of polymer comprising repeating units of formula I aqueous solution to achieve 1% polymer (wt/wt), and propylene glycol balance to 100%.

The polymers comprising repeating units of formula I were formulated in the liquid detergent compositions given in Table 10 below.

TABLE 10
Liquid detergent compositions

| | Comparative | Comparative | |
|---|---|---|---|
| | example 12 | example 13 | Example 14 |
| | Part by | Part by | Part by |
| Composition | weight | weight | weight |
| Liquid detergent base, 10% | 90.0 | 90.0 | 90.0 |
| hole | | | |
| Sokalan HP20** (80% solid) | — | 1.25 | — |
| Example 6 (52.3% solid) | — | — | 1.91 |
| Propylene glycol | To 100 | To 100 | To 100 |

**Sokalan HP20 is one of industrial benchmark for anti-redeposition application in laundry. It is an ethoxylated polyethyleneimine.

The soil anti-redeposition test performance is carried out on the following test fabrics:
Test fabric 1: 100% polyester, Style #777 from Testfabrics
Test fabric 2: 50%/50% polyester-cotton blend, Style #7422 from Testfabrics
Test fabric 3: 100% polyester, W-30A from WFK
Test fabric 4: 65%/35% polyester-cotton blend, W-20A from WFK
Test fabric 5: 100% Cotton from, W-10A from WFK
Test fabric 6: 100% Bleached Cotton, Interlock Knit, T-460 from Testfabrics

### Washing:

Prior to be used in the washing experiments, the test fabrics and the ballast fabric load were pretreated by washing them twice with the detergent composition without polymer i.e. Comparative Example 12 using a typical front load washing machine with washing program for cotton at 60° C. The pretreated fabrics were line-dried at temperature 22 degree centigrade with humidity of 60%. The purpose of the pretreatment is to remove any finishing substances from the fabrics.

The test fabrics were cut into squares 7 cm×7 cm in size in three replicates and were washed in a LaunderOmeter® (SDLATLAS) with following conditions:
Washing temperature: 40° C.
Washing time: 20 minutes
Water volume: 500 ml
Water hardness: 25° fH with Ca:Mg molar ratio=4:1
Detergent dosage: 2.0 grams per liter of the washing liquor
Clay-peanut butter soil level: 0.5 gram per liter of the washing liquor
Ballast load: 50 grams of terry bath towel (100% cotton, white color, e.g. Vagsjon from IKEA) cut into small swatches
Number of steel balls: 50 pieces of steel balls
LaunderOmeter rotation: 40 RPM.

After the wash, the fabrics were rinse twice with Singapore tab water for 1 minute each. Finally, the fabrics were line-dried at temperature 22 degree centigrade with humidity of 60%. The washing was repeated 5 times.

### Evaluation:

The test fabric squares before washing experiment (referred to as white) and after 5 cumulative washes (referred to as wash) were analyzed with the ColorQuest XE reflectance colorimeter from HunterLab to measure their whiteness index according to CIE (The International Commission on Illumination) which is equivalent to the whiteness index published in ASTM Method E313 in 1998.

The anti-redeposition performance of the laundry detergent compositions with the polymers comprising repeating units of formula I according to the present invention and of the laundry detergent composition without polymer is assessed based on the following formula:

$$Δ WI CIE = WI {CIE}_{w h i t e} - WI {CIE}_{w a s h}$$

The effectiveness of the soil anti-redeposition of the laundry detergent compositions with the polymers comprising repeating units of formula I according to the present invention is reflected with lower ΔWI CIE values as shown in Table 11 below.

TABLE 11
The effectiveness of the soil anti-redeposition
of the laundry detergent compositions with the
polymers comprising repeating units of formula I.

| Liquid Laundry | | | |
|---|---|---|---|
| Composition/Test | Comparative | Comparative | |
| fabrics | Example 12 | Example 13 | Example 14 |
| Test fabric 1 | 6.82 | 1.24 | 1.03 |
| Test fabric 2 | 14.34 | 4.99 | 3.69 |
| Test fabric 3 | 6.24 | 0.62 | 0.66 |
| Test fabric 4 | 10.18 | 3.83 | 3.13 |
| Test fabric 5 | 1.68 | 0.16 | 0.24 |
| Test fabric 6 | 7.07 | 4.74 | 4.99 |
| Total | 46.33 | 15.58 | 13.73 |

As shown by the results in Table 11, the presence of the polymers comprising repeating units of formula I of the present invention in the laundry detergent compositions improves the soil anti-redeposition performance across different type of test fabrics.

### D2. Second Anti-Redeposition Trial

Another soil anti-redeposition performance was evaluated using a Sebum CB-3. The serbum was prepared by mixing 32.8% (wt/wt) of Sebum Bey from WFK (Testgewebe GmbH), 32.8% (wt/wt) of vegetable oil from supermarket, 16.4% (wt/wt) of propylene glycol from SinoPharm, 1.6% (wt/wt) of carbon black from SinoPharm, and 16.4% (wt/wt) of mineral oil from SinoPharm. The mixture was blended well with an overhead stirrer for 30 minutes to obtain homogenous mixture.

The composition of ECE-2 standard detergent base for the test is given in Table 12

TABLE 12
composition of ECE - 2 detergent base

| | Part by |
|---|---|
| Composition | weight |
| Linear sodium alkyl benzene sulphonate (mean length | 9.7 |
| of alkane chain C11.5) | |
| Ethoxylated fatty alcohol C12-18 (7 EO units) | 5.2 |
| Sodium soap, chain length C12-1746%:C18-2054% | 3.6 |
| Foam inhibitor (DC-4248S) | 4.5 |
| Sodium aluminium silicate (Zeolite 4A) | 32.5 |
| Sodium carbonate | 11.8 |
| Sodium salt of copolymer from acrylic and maleic acid | 5.2 |
| Sodium silicate (SiO2:Na2O = 3.3:1) | 3.4 |
| Carboxy methyl cellulose (CMC) | 1.3 |
| Diethylene triamine penta(methylene phosphonic acid) | 0.8 |
| Sodium sulphate | 9.8 |
| Water | 12.2 |

The polymers of formula (I) were formulated in the liquid detergent compositions given in Table 13

TABLE 13
Liquid detergent compositions

| | Comparative | Comparative | Example | Example | Example | Example |
|---|---|---|---|---|---|---|
| | example 25 | example 26 | 27 | 28 | 29 | 30 |
| | Part by | Part by | Part by | Part by | Part by | Part by |
| Composition | weight | weight | weight | weight | weight | weight |
| Liquid detergent | 45 | 45 | 45 | 45 | 45 | 45 |
| base ECE-2 | | | | | | |
| Sokalan HP20 | — | 0.625 | — | — | — | — |
| (80% solid) | | | | | | |
| Example 21 | — | — | 1.12 | — | — | — |
| Example 22 | — | — | — | 1.08 | — | — |
| Example 23 | — | — | — | — | 1.04 | — |
| Example 24 | — | — | — | — | — | 0.85 |
| Water | To 50 | To 50 | To 50 | To 50 | To 50 | To 50 |

The soil anti-redeposition test performance is carried out on the following test fabrics:
Test fabric 1: 100% polyester, Style #777 from Testfabrics
Test fabric 2: 50%/50% polyester-cotton blend, Style #7422 from Testfabrics
Test fabric 3: 100% polyester, W-30A from WFK
Test fabric 4: 65%/35% polyester-cotton blend, W-20A from WFK
Test fabric 5: 100% Cotton from, W-10A from WFK
Test fabric 6: 100% Bleached Cotton, Interlock Knit, T-460 from Testfabrics

### Washing:

Prior to be used in the washing experiments, the test fabrics and the ballast fabric load were pre-treated by washing them twice with the detergent composition without polymer i.e. comparative example 1 using a typical front load washing machine with washing program for cotton at 60° C. The pre-treated fabrics were line-dried at temperature 23 degree centigrade with humidity of 60%. The purpose of the pre-treatment is to remove any finishing substances from the fabrics.
The test fabrics were cut into squares 7 cm×7 cm in size in three replicates and were washed in a LaunderOmeter® (SDLATLAS) with following conditions:
Washing temperature: 40° C.
Washing time: 20 minutes
Water volume: 250 ml
Water hardness: 25° fH with Ca:Mg molar ratio=4:1
Detergent dosage: 5.0 grams per liter of the washing liquor
Polymer solution dosage: 2 grams per liter of the washing liquor
Soil dosage: 0.5 gram per liter of the washing liquor
Ballast load: 25 grams of terry bath towel (100% cotton, white color, e.g. Vagsjon from IKEA) cut into small swatches
Number of steel balls: 25 pieces of steel balls
LaunderOmeter rotation: 40 RPM.

After the wash, the fabrics were rinse twice with tap water for 1 minute each. Finally, the fabrics were line-dried at temperature 23 degree centigrade with humidity of 60%. The washing was repeated 5 times.

### Evaluation:

The test fabric squares before washing experiment (referred to as white) and after 5 cumulative washes (referred to as wash) were analyzed with the Agera reflectance colorimeter from HunterLab to measure their whiteness index according to CIE (The International Commission on Illumination) which is equivalent to the whiteness index published in ASTM Method E313 in 1998.

The anti-redeposition performance of the laundry detergent compositions with the polymers of formula (I) according to the present invention and of the laundry detergent composition without polymer is assessed based on the following formula:

$$Δ WI CIE = WI {CIE}_{w h i t e} - WI {CIE}_{w a s h}$$

The effectiveness of the soil anti-redeposition of the laundry detergent compositions with the polymers of formula (I) according to the present invention is reflected with lower ΔWI CIE values as shown in Table 14.

TABLE 14
The effectiveness of the soil anti-redeposition of the laundry
detergent compositions with the polymers of formula (I)

| Liquid Laundry | | | | | | |
|---|---|---|---|---|---|---|
| Composition/ | Comparative | Comparative | Example | Example | Example | Example |
| Test fabrics | Example 25 | Example 26 | 27 | 28 | 29 | 30 |
| Test fabric 1 | 37.34 | 34.82 | 25.50 | 32.77 | 29.29 | 29.52 |
| Test fabric 2 | 23.16 | 24.84 | 17.10 | 21.39 | 17.26 | 15.73 |
| Test fabric 3 | 13.72 | 18.14 | 10.88 | 12.78 | 16.02 | 12.82 |
| Test fabric 4 | 6.55 | 13.39 | 5.91 | 5.65 | 5.43 | 5.64 |
| Test fabric 5 | 0.56 | 9.09 | 2.50 | 3.02 | 2.74 | 2.45 |
| Test fabric 6 | 0.87 | 7.50 | 3.11 | 3.05 | 1.78 | 2.64 |
| Total | 82.20 | 107.78 | 65.00 | 78.65 | 72.52 | 68.80 |

As shown by the results in Table 14, the presence of the polymers of the present invention in the laundry detergent compositions improves the soil anti-redeposition performance across different types of test fabrics.

### E. Antimicrobial Performance

Laundry Detergent compositions for the antimicrobial performance test are shown in Table 15 below.

TABLE 15
the liquid detergent compositions.

| | Example 15 | Example 16 | Example 17 | Example 18 | Example 19 |
|---|---|---|---|---|---|
| Concentrated liquid | Part by | Part by | Part by | Part by | Part by |
| laundry composition | weight | weight | weight | weight | weight |
| Linear alkyl benzene | — | 10.0 | 10.0 | 10.0 | 10.0 |
| sulphonate, sodium salt | | | | | |
| Ethoxylated fatty alcohol | 15.0 | 10.0 | 10.0 | 10.0 | 10.0 |
| C₁₂₋₁₈ (7 EO units) | | | | | |
| Sodium fatty acid soap | 3.0 | — | — | — | — |
| (C₁₀₋₁₈) | | | | | |
| Sodium laureth sulphate | 9.0 | 5.0 | 5.0 | 5.0 | 5.0 |
| (2 EO units) | | | | | |
| Propylene glycol | 6.5 | 6.5 | 6.5 | 6.5 | 6.5 |
| Example 6 | 1.3 | — | — | — | — |
| Example 6 | — | 1.3 | — | — | — |
| Example 7 | — | — | 1.3 | — | — |
| Example 8 | — | — | — | 1.3 | — |
| Example 9 | — | — | — | — | 1.3 |
| Water | To 100 | To 100 | To 100 | To 100 | To 100 |
| Fabric | Cotton | Cotton | Cotton | Cotton | Cotton |
| Wash cycle | 1 | 3 | 3 | 3 | 3 |

Test fabrics: 100% Cotton from, W-10A from WFK

Prior to be used in the antimicrobial experiments, the test fabric was pre-treated by treated them twice with Singapore tap water without any cleaning composition using a typical front load washing machine with washing program for cotton at 90° C. The pre-treated fabrics were line-dried at temperature 22 degree centigrade with humidity of 60%. The purpose of the pre-treatment is to remove any finishing substances from the fabrics.

### Example 15

The standard cotton fabric (W-10A from WFK) was washed using a LaunderOmeter® (SDLATLAS) with the detergent composition according to the Example 15. The detergent dosage is 5 gram per liter. The volume of the washing liquor is 500 ml. Fabric to liquor ratio (wt/wt) is 1 to 10. Singapore tap water with maximum hardness of 150 ppm was used as the water source. The washing was done at temperature of 40 degree centigrade for 30 minutes. In the LaunderOmeter® pot, 50 pieces steel balls were added. After the laundry, the fabric was rinsed twice with Singapore tab water for 1 minute each. Finally, the fabric was line-dried at temperature 22 degree centigrade with humidity of 60%.

### Example 16 to 19

The standard cotton fabric (W-10A from WFK) was washed using a LaunderOmeter® (SDLATLAS) with the detergent compositions according to the Example 16 to 19. The detergent dosage is 5 gram per liter. The volume of the washing liquor is 500 ml. Fabric to liquor ratio (wt/wt) is 1 to 10. Singapore tap water with maximum hardness of 150 ppm was used as the water source. The washing was done at temperature of 40 degree centigrade for 30 minutes. In the LaunderOmeter® pot, 50 pieces steel balls were added. After the laundry, the fabrics were rinsed twice with Singapore tab water for 1 minute each. The washing was repeated 3 times. Finally the fabrics were line-dried at temperature 22 degree centigrade with humidity of 60%.

### 1. Tests According to AATCC100 Antimicrobial Test Protocol

The washed and dried fabrics according to Example 15 to 19 were cut into square swatches with size of 3.8×3.8±0.1 cm. The number of swatches needed for the test is equal to 1.0±0.1 gram. Two bacteria strains i.e. Staphylococcus aureus (ATCC 6538) and Klebsiella pneumonia (ATCC 4352) were used for the test. The detail test was done according to the protocol AATCC TM 100-2019 which is available online via https://members.aatcc.org/store/tm100/513/.

The test results were shown in the Table 16 and 17 below.

The antimicrobial test results showed that the polymer comprising repeating units of formula I is capable of inhibiting the growth of the test bacteria.

TABLE 16
Count of Staphylococcus aureus (ATCC 6538) test bacteria recovered from the inoculated fabric.

| Example | Example 15 | Example 16 | Example 17 | Example 18 | Example 19 |
|---|---|---|---|---|---|
| Untreated Fabric (viability | 200,000 | 240,000 | 240,000 | 240,000 | 240,000 |
| control), bacteria count at | | | | | |
| 0 contact time, CFU | | | | | |
| Untreated Fabric (viability | 4,500,000 | 3,200,000 | 3,200,000 | 3,200,000 | 3,200,000 |
| control) bacteria count at | | | | | |
| 24 hours contact time, CFU | | | | | |
| Treated Fabric, bacteria | 200,000 | 240,000 | 240,000 | 240,000 | 240,000 |
| count at 0 contact time, CFU | | | | | |
| Treated Fabric, bacteria | <100 | 1,200 | <100 | 320 | <100 |
| count at 24 hours contact | | | | | |
| time, CFU | | | | | |

TABLE 17
Count of Klebsiella Pneumoniae (AATCC 4352) test
bacteria recovered from the inoculated fabric.

| Example | Example 15 | Example 16 | Example 17 | Example 18 | Example 19 |
|---|---|---|---|---|---|
| Untreated Fabric (viability | 100,000 | 160,000 | 160,000 | 160,000 | 160,000 |
| control), bacteria count at | | | | | |
| 0 contact time, CFU | | | | | |
| Untreated Fabric (viability | 46,000,000 | 53,000,000 | 53,000,000 | 53,000,000 | 53,000,000 |
| control) bacteria count at | | | | | |
| 24 hours contact time, CFU | | | | | |
| Treated Fabric, bacteria | 100,000 | 160,000 | 160,000 | 160,000 | 160,000 |
| count at 0 contact time, CFU | | | | | |
| Treated Fabric, bacteria | 7,200,000 | 1,300,000 | 260,000 | 650 | 5,300,000 |
| count at 24 hours contact | | | | | |
| time, CFU | | | | | |

### 2. Second Antimicrobial Performance Tests

Laundry Detergent compositions for these antimicrobial performance tests are shown in Table 18.

TABLE 18
the polymer solutions compositions

| Concentrated | Example 31 | Example 32 | Example 33 | Example 34 |
|---|---|---|---|---|
| liquid laundry | Part by | Part by | Part by | Part by |
| composition | weight | weight | weight | weight |
| Liquid | 90 | 90 | 90 | 90 |
| detergent base | | | | |
| ECE-2 | | | | |
| Example 21 | 1.3 | — | — | — |
| Example 22 | — | 1.3 | — | — |
| Example 23 | — | — | 1.3 | — |
| Example 24 | — | — | — | 1.3 |
| Water | To 100 | To 100 | To 100 | To 100 |
| Fabric | Cotton | Cotton | Cotton | Cotton |
| Wash cycle | 3 | 3 | 3 | 3 |

Test fabrics: W-10A 100% Cotton from, from WFK

Prior to be used in the antimicrobial experiments, the test fabric was pretreated by treated them twice with tap water without any cleaning composition using a typical front load washing machine with washing program for cotton at 90° C. The pretreated fabrics were line-dried at temperature 23 degree centigrade with humidity of 60%. The purpose of the pretreatment is to remove any finishing substances from the fabrics.

### Example 31 to 34

The standard cotton fabric (W-10A from WFK) was washed with LaunderOmeter® (SDLATLAS) with the ECE-2 detergent and polymer solutions compositions according to the Example 31 to 34. The detergent dosage is 5 gram per liter. The polymer solution dosage is 5 g per liter. The volume of the washing liquor is 250 ml. Fabric to liquor ratio (wt/wt) is 1 to 10. tap water with maximum hardness of 350 ppm was used as the water source. The washing was done at temperature of 40 degree centigrade for 30 minutes. In each LaunderOmeter® pot, 25 pieces steel balls was added. After the laundry, the fabrics were rinse twice with tap water for 1 minute each. The washing was repeated 3 times. Finally the fabrics were line-dried at temperature 23 degree centigrade with humidity of 60%.

### AATCC100 Antimicrobial Test

The washed and dried fabrics were cut into round swatches with diameter of 4.8±0.1 cm. The number of swatches needed for the test is equal to 1.0±0.1 gram. Bacteria Staphylococcus aureus (ATCC 6538) was used for the test. The detail test was done according to the protocol AATCC TM 100-2019 which is available online via https://members.aatcc.org/store/tm100/513/.

The test results are shown in Table 19.

The antimicrobial test results show that the polymer of formula (I) is capable of inhibiting the growth of the test bacteria.

Table 19: Count of Staphylococcus aureus (ATCC 6538) test bacteria recovered from the inoculated fabric

TABLE 19
Count of Staphylococcus aureus (ATCC 6538) test
bacteria recovered from the inoculated fabric

| | Example | Example | Example | Example |
|---|---|---|---|---|
| Example | 31 | 32 | 33 | 34 |
| Treated Fabric, bacteria | 14,000 | 70,000 | 4,000 | 14,000 |
| count at 0 contact time, | | | | |
| CFU | | | | |
| Treated Fabric, bacteria | <100 | <100 | <100 | <100 |
| count at 24 hours contact | | | | |
| time, CFU | | | | |

1. A polymer comprising the following repeating unit having a formula (I): 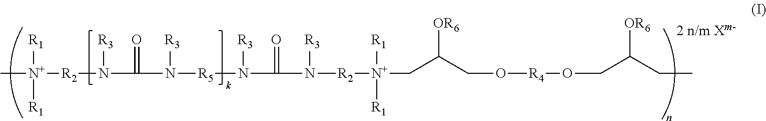
wherein:
R₁ are each independently a hydrogen atom, a C₁ to C₄ alkyl or hydroxyalkyl group, or a C₂ to C₄ alkenyl group;
R₂ are each independently a C₂ to C₁₀ alkylene group;
R₃ are each independently a hydrogen atom, a C₁ to C₄ alkyl or hydroxyalkyl group, or a C₂ to C₄ alkenyl group;
R₄ is selected in the group consisting of:
—CH₂—CH(OH)—CH₂—; —CH₂—CH(CH₂OH)—; —CH₂—CH(O—CH₂—CH(OR₆)—CH₂)—CH₂—; —CH₂—CH(CH₂O—CH₂—CH(OR₆)—CH₂)—; a C₃ to C₁₀ alkylene; an arylene and an oxyalkylene group of formula A:
(—CHR₇CH₂)ₐ—(OCH₂CHR₈)_{b}—(OCH₂CHR₉)_{c}—(OCH₂CHR₁₀)_{d} (A)
wherein
“a” represents 1;
“b” represents an integer of 1 or more;
“c” and “d” represent independently from one another an integer of 0 or more; and
R₇, R₈, R₉ and R₁₀ represent independently from one another a hydrogen atom or a C₁ to C₄ alkyl group;
R₅ represents an alkylene group, an oxyalkylene group of formula A, a cycloalkylene group, or an arylene group, optionally substituted and/or interrupted by one or more heteroatoms or heteroatom containing groups;
R₆ represents a hydrogen atom or a radical deriving from any oxirane containing compound present in the reaction mixture during the synthesis process of the polymer and that reacted by ring opening reaction with any OH or O⁻ group present on the polymer during its synthesis;
k represents a positive integer from 0 to 20;
n represents a positive integer from 1 to 50
m represents a positive integer from 1 to 3 and
X^{m-} represents a m− valent counterion.

2. The polymer according to claim 1, wherein k equals zero.

3. The polymer according to claim 1, wherein k is greater than 1.

4. The polymer according to claim 1, wherein
R₁ are C₁ alkyl groups;
R₂ are C₂ or C₃ alkylene group;
R₃ are hydrogen atoms.

5. The polymer according to claim 1, wherein R₄ is selected in the group consisting of:
—CH₂—CH(OH)—CH₂—; —CH₂—CH(CH₂OH)—; —CH₂—CH(O—CH₂—CH(OR₆)—CH₂)—CH₂—; —CH₂—CH(CH₂O—CH₂—CH(OR₆)—CH₂)—; a C₃ to C₁₀ alkylene; an arylene and an oxyalkylene group of formula A:
(—CHR₇CH₂)ₐ—(OCH₂CHR₈)_{b}—(OCH₂CHR₉)_{c}—(OCH₂CHR₁₀)_{d} (A)
wherein
“a” represents 1;
“b” represents an integer of 1 or more;
“c” and “d” represent independently from one another an integer of 0 or more; and
R₇ is methyl or hydrogen, R₈ is hydrogen, R₉ is hydrogen or methyl and R₁₀ is methyl.

6. The polymer according to claim 1, wherein in formula I
n represents a positive integer from 1 to 50
m is 1 and
X^{m-} is CH3COO⁻.

7. The polymer according to claim 1, having a weight average molecular weight ranging from 1 to 100 kg/mol.

8. The polymer according to claim 1, having a cationic charge density ranging from 0.1 to 5.4 mmol/g.

9. A process for preparing a polymer according to claim 1, comprising:
a step (i) of reacting a compound of formula II: 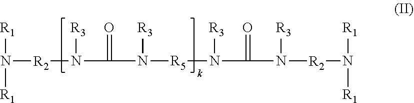
wherein
R₁ are each independently a hydrogen atom, a C₁ to C₄ alkyl or hydroxyalkyl group, or a C₂ to C₄ alkenyl group;
R₂ are each independently a C₂ to C₁₀ alkylene group;
R₃ are each independently a hydrogen atom, a C₁ to C₄ alkyl or hydroxyalkyl group, or a C₂ to C₄ alkenyl group;
R₅ represents an alkylene group, an oxyalkylene group of formula A, a cycloalkylene group, or an arylene group, optionally substituted and/or interrupted by one or more heteroatoms or heteroatom containing groups;
k represents a positive integer from 0 to 20
with a compound of formula III: 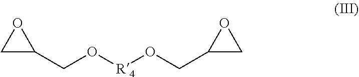
wherein
R′4 is selected in the group consisting of
—CH₂—CH(OH)—CH₂—; —CH₂—CH(CH₂OH)—; —CH₂—CH(O—CH₂—CHO—CH₂)—CH₂—; —CH₂—CH(CH₂O—CH₂—CHO—CH₂)— and an oxyalkylene group of formula A:
(—CHR₇CH₂)ₐ—(OCH₂CHR₈)_{b}—(OCH₂CHR₉)_{c}—(OCH₂CHR₁₀)_{d} (A)
wherein
“a” represents 1;
“b” represents an integer of 1 or more;
“c” and “d” represent independently from one another an integer of 0 or more; and
R₇, R₈, R₉ and R₁₀ represent independently from one another a hydrogen atom or a C₁ to C₄ alkyl group;
thus leading to a polymer comprising repeating units of formula I as defined in claim 1 wherein R₆═H
and optionally one or more subsequent step(s) ii) of ring opening reaction between any oxirane containing compound present in the reaction mixture and any OH or O⁻ group present on the polymer comprising repeating units of formula I as defined in claim 1;
thus leading to a polymer comprising repeating units of formula I as defined in claim 1, wherein at least some R₆ groups are derived from said ring opening reaction between any oxirane containing compound present in the reaction mixture during the synthesis process of the polymer of formula I with any OH or O− group present on the polymer formula I in claim 1 during its synthesis.

10. The process according to claim 9, wherein the molar ratio between the compound of formula II and the compound of formula III is ranging from 0.5 to 1.5.

11. The process according to claim 9, wherein step i) is performed in the presence of an acidic compound of formula XH, wherein XH is selected among hydrochloric acid, sulfuric acid, sulfonic acid, phosphoric acid, phosphonic acid, any carboxylic acid as acetic acid, lactic acid, citric acid, succinic acid, maleic acid, tartaric acid, benzoic acid, phthalic acid and its isomers, organic sulfonic acids.

12. The process according to claim 9, wherein the compound of formula II is prepared by reaction of
a diamine of formula IV: 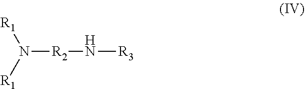
wherein R₁, R₂ and R₃ are as defined in claim 9;
and optionally with a diamine of formula IV′:
H₂N—R₅—NH₂ (IV′)
wherein R₅ is as defined in claim 9;
with urea of formula V NH₂CONH₂ (V);
in a molar ratio IV:V:IV′ of at least 2:1:0 to 0.4:1:0.8.

13. The process according to claim 9, wherein the compound of formula III is such that R′₄ is selected in the group consisting of:
—CH₂—CH(OH)—CH₂—; —CH₂—CH(CH₂OH)—; —CH₂—CH(O—CH₂—CHO—CH₂)—CH₂—; —CH₂—CH(CH₂O—CH₂—CHO—CH₂)—; a C₃ to C₁₀ alkylene; an arylene and an oxyalkylene group of formula A:
(—CHR₇CH₂)ₐ—(OCH₂CHR₈)_{b}—(OCH₂CHR₉)_{c}—(OCH₂CHR₁₀)_{d} (A)
wherein
“a” represents 1;
“b” represents an integer of 1 or more, preferably up to 70;
“c” and “d” represent independently from one another an integer of 0 or more, preferably up to 70; and
R₇ is methyl or hydrogen, R₈ is hydrogen, R₉ is hydrogen or methyl and R₁₀ is methyl.

14. A home and personal care composition, the home and personal care composition comprising:
the polymer according to claim 1.

15. An industrial and institutional cleaning composition, the industrial and institutional cleaning composition comprising:
the polymer according to claim 1.

16. A composition comprising:
an anti-microbial agent comprising the polymer according to claim 1,
wherein the composition is a hard surface cleaning composition, a dish wash cleaning composition, or a hair care composition.

17. A laundry composition, the laundry composition comprising:
one or more selected from a dye fixing agent, a transfer inhibitor agent, a soil anti-redeposition agent, a soil release agent, or a laundry additives deposition agent,
wherein the dye fixing agent, the transfer inhibitor agent, the soil anti-redeposition agent, the soil release agent, and the laundry additives deposition agent each independently comprise the polymer according to claim 1.

18. A dish wash composition, the dish wash composition comprising:
one or more selected from a soil anti-redeposition agent, a soil release agent, or a shining agent,
wherein the soil anti-redeposition agent, the soil release agent, and the shining agent each independently comprise the polymer according to claim 1.

19. A formulation comprising:
(i) the polymer as defined in claim 1; and
(ii) an adjuvant selected from a surfactant and/or a thickening agent.

20. The polymer according to claim 1, wherein k is between 1 and 20.
